(19) United States
(12) Patent Application Publication
(10) Pub. No.: US 2010/0270361 A1
(43) Pub. Date: Oct. 28, 2010

(54) Device and Method For Applying a Flow Agent For Hard Soldering of Parts

(75) Inventors: Peter Englert, Bad Friedrichshall (DE); Ingo Trautwein, Bietigheim-Bissingen (DE); Joan Ferrer, Barcelona (ES); Vincenzo Sabetta, Miamisburg, OH (US)

Correspondence Address: FOLEY AND LARDNER LLP;SUITE 500, 3000 K STREET NW, WASHINGTON, DC, 20007, US

(73) Assignee: BEHR GMBH & CO.,, STUTTGART (DE)

(21) Appl. No.: 10/546,866

(22) PCT Filed: Nov. 14, 2003
(86) PCT No.: PCT/EP03/12763

§ 371 Date: Jan. 23, 2008

(30) Foreign Application Priority Data
Feb. 26, 2003 (EP) 03-004-158.6

(51) Int. Cl. B23K 1/00; B23K 31/02

(52) U.S. Cl. 228/183; 228/41; 228/207; 228/262.51

(57) ABSTRACT

The invention relates to an apparatus and a process for the preferably uneven application of flux to a material surface, in particular to the finned side of a plate of a plate-type radiator.

The invention relates to an apparatus and a process for applying a flux for brazing parts, in particular for producing plate-type radiators as used in motor vehicles, in accordance with the preamble of claim 1 or or 13 or 14. The invention also relates to a heat exchanger using a corresponding process.

It is currently customary to use special brazing processes, in particular what is known as NOCOLOK® brazing, to braze solder-plated individual parts in particular for heat exchangers, i.e. in particular of radiators, evaporators, condensers, etc. as used in the automotive sector, if the base material used is aluminum or aluminum alloys.

NOCOLOK® brazing is described in principle in DE-A 26 14 872 as a process for joining aluminum components using an aluminum brazing alloy with a melting point below that of the aluminum components, by heating the assembled components to a temperature above the melting point of the brazing alloy and below the melting point of the components in the presence of a potassium fluoroaluminate flux which is substantially devoid of unreacted KF. This known process is distinguished by the fact that the flux and the brazing alloy are applied to the surfaces of at least one of the components as an aqueous suspension of finely dispersed flux and metal powder, the film of suspension is dried and the dust-free inert gas atmosphere (if appropriate after the parts have been assembled) is used for brazing, with the application of the flux/brazing alloy suspension being controlled in such a way that from 40 to 150 g/m² are applied and the ratio of flux to brazing alloy is selected in such a way that at least 5 g/m² of flux are deposited.

On account of the special materials properties of aluminum or aluminum alloys, in the known brazing process it is necessary to apply a noncorrosive, non-hygroscopic flux. In the NOCOLOK® brazing process (CAB—Controlled Atmosphere Brazing), a flux based on potassium fluoroaluminate of the empirical formula K₍₁₋₃₎AlF₍₄₋₆₎ is used for this purpose. This flux is in the form of a eutectic, melts at a temperature of 562° C. to 572° C. and removes the aluminum oxide which is always present as a surface impurity on the aluminum itself. As a result, the surface of the Al material is for a brief time rendered accessible to further processing steps, such as brazing, which is also known in the specialist field as “activation of the surface”.

The non-hygroscopic flux mentioned above wets the surface, and the solder, when the solder plating starts to melt at a temperature of 577° C., can be drawn freely into the soldering gaps through capillary action. Therefore, completely sealed brazing in a reliable manufacturing process is not possible without an application of flux appropriate to the brazing situation.

It is usual for the flux mentioned to be applied in the following ways, a process known in the specialist field as fluxing:
a) by using a spray fluxing device to spray it onto the surface as an aqueous suspension, followed by blowing out the meshes and drying;
b) by brushing on an aqueous suspension, followed by subsequent drying; and
c) by the flux being applied locally by means of a cannula as a pasty suspension in various glycols and/or glycol ethers, followed by subsequent drying.

The variant of applying the flux described under a) is primarily used for the fluxing of heat exchanger meshes, for fin/tube brazing or, as illustrated in FIG. 6, for fluxing plates, for example of a plate-type radiator or plate-type evaporator. In this case, the workpiece is usually sprayed at a right angle with the aid of a spray gun arranged centrally with respect to the workpiece or its direction of transport, the spray jet being dimensioned and formed in such a manner that an overspray is present on both sides, i.e. the right-hand and left-hand sides of the center of the workpiece i.e. that the spray jet is designed to be wider than is actually necessary. The spray jet leads to flux being sprayed on in a uniform thickness.

However, conventional fluxing still leaves something to be desired; in particular excess quantities of flux may be supplied, which leads to increased costs.

It is an object of the invention to provide an improved apparatus for applying flux. A further object is to provide a process for more optimum fluxing. Another object of the invention is to provide heat exchangers which have an optimized fluxing.

This object is achieved by an apparatus having the features of claim 1. This object is also achieved by an apparatus having the features of claim 3. This object is also achieved by a process having the features of claim 13. Furthermore, this object is achieved by a process having the features of claim 14. The object according to the invention is also achieved by heat exchangers as described in claim 18. Advantageous configurations form the subject matter of the subclaims.

The invention provides an apparatus having a fluxing apparatus for the automated application of flux to a material surface using a spraying apparatus, such as for example a spray nozzle or spray gun which is arranged, inclined at an angle of 30° to 60° with respect to the material surface, preferably at an angle of approximately 40°, in a region in the vicinity of an edge of the material surface.

This apparatus is used in particular for the targeted spraying of plates of a plate-type heat exchanger with flux, during which process the material surfaces which have been provided with flux are then joined to suitably treated other material surfaces by means of NOCOLOK® brazing.

The earlier application DE 101 41 883, the disclosure of which is hereby expressly incorporated by reference in the content of disclosure of the present application, has disclosed flux compositions which can preferably be used for the process according to the invention.

It is preferable for the material surface to be arranged horizontally. In this case, the plate which is to be fluxed is preferably positioned with its finned side facing upward on a conveyor apparatus, for example a conveyor belt, and successively passes through various stations, such as a spraying station, a drying station, a monitoring station. The spray gun is slightly laterally offset with respect to the plate in the vicinity of a cup-like region of the plate which is located in the vicinity of an edge of the plate.

In an exemplary embodiment of the invention, the arrangement of the spraying apparatus can be selected in such a manner that the component is sprayed or coated in such a manner that the higher quantity of flux required for tightly sealed brazing is applied in a defined region of the component, whereas a reduced quantity of the flux, for example for the fin brazing, is applied in another region of the component.

The apparatus preferably has a monitoring apparatus which is used to monitor the flux coating. This monitoring apparatus is preferably formed by one or more monitoring units which, for example, monitor the spray jet and in particular also the presence of a sufficient flux coating, which is not too thick, in one or more defined regions of the component.

The monitoring apparatus is preferably an optical monitoring apparatus. This has the advantage of accurate yet rapid monitoring in production at a high process rate. This optical monitoring apparatus may in particular be a laser apparatus with at least one emitter and at least one receiver. A two-channel laser is preferably provided for monitoring the layer thickness or layer weight, which is preferably in a range from 0.01 to 0.15 g/cm², and in particular in the range from 0.02 to 0.1 g/cm².

In the text which follows, the invention is explained in more detail on the basis of an exemplary embodiment and with reference to the drawing, in which:

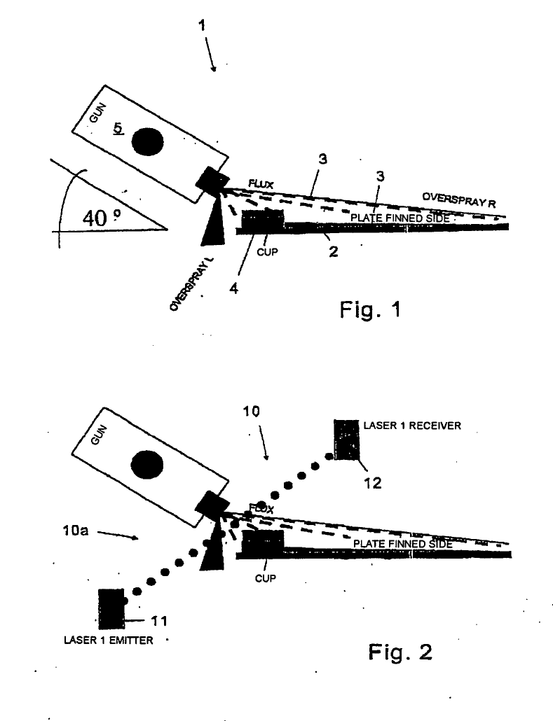

FIG. 1 diagrammatically depicts a fin-side fluxing in accordance with the invention of a plate for a plate-type radiator,

FIG. 2 shows a monitoring apparatus for monitoring the fluxing operation shown in FIG. 1,

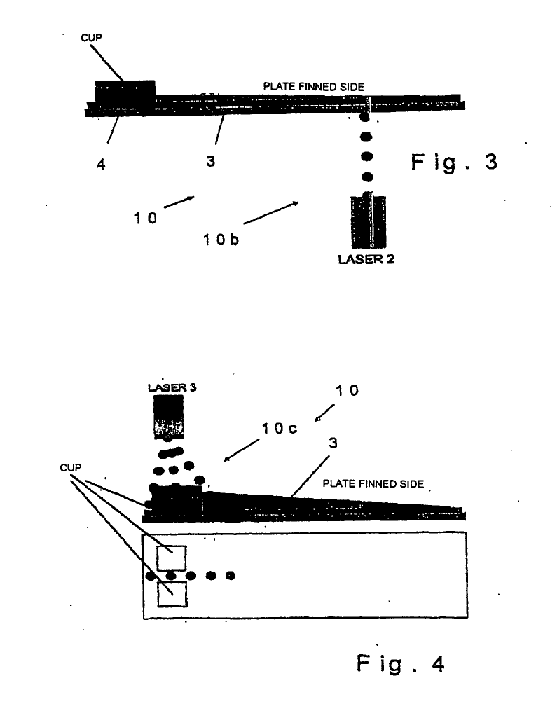

FIG. 3 shows a second monitoring apparatus,

FIG. 4 shows a third monitoring apparatus,

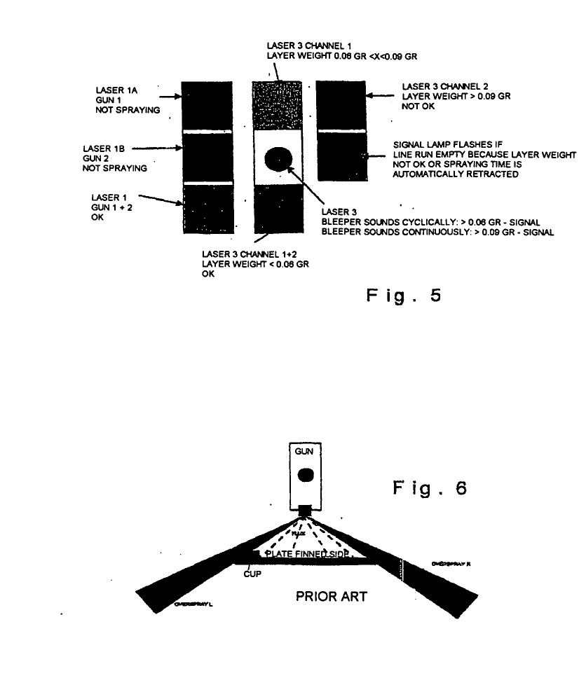

FIG. 5 shows a traffic light system for monitoring the individual monitoring apparatuses, and

FIG. 6 diagrammatically depicts a fin-side fluxing in accordance with the invention of a plate for a plate-type radiator in accordance with the prior art.

FIG. 1 shows the fluxing operation, i.e. the operation of providing flux, with the aid of an automated fluxing apparatus 1. During this operation, a workpiece 2 is sprayed with flux 3 on one side. In the present instance, the workpiece 2 is a plate for a plate-type radiator as used in motor vehicles, having a finned side and a studded side. The fluxing apparatus 1 illustrated in FIG. 1 sprays the finned side of the plate. The plate is transported resting flat by means of a conveyor apparatus (not shown), for example by means of a conveyor belt, in the direction of viewing of FIG. 1, with the finned side of the plate, which is to be sprayed, facing upward. The spraying operation is carried out cyclically.

The plate has a cup-like region 4, which is indicated by “cup” in FIGS. 1 to 4 and is to be brazed tightly to cup-like regions of similar design on other plates. This cup-like region 4 is arranged laterally in the vicinity of the edge of the plate. The plate is arranged in such a manner on the conveyor apparatus that the cup-like region 4 lies on one side thereof.

To ensure reliable brazing, according to the invention a spraying apparatus, such as a spray nozzle or spray gun, 5, comprising a spraying apparatus, such as spray nozzle or spray gun, which sprays the flux 3 to be sprayed as a spray fan jet, is arranged at an angle of approximately 40° to the horizontal. The spray jet comprising flux 3 from the spray gun 5 is fanned out in such a manner that flux is sprayed beyond the workpiece 2 on the right-hand and left-hand sides (“overspray L” and “overspray R”). The core zone of the spray jet in this case strikes the cup-like region 4 of the plate, which is arranged in the vicinity of the spray gun 5.

The flux 3 which is sprayed as “overspray R” and is substantially in the form of a mist is used to ensure sufficient fin brazing. Excess quantities of sprayed flux 3, in particular the flux 3 which is sprayed as “overspray L”, is collected by means of funnels or the like at the bottom and returned to the fin-side flux circuit.

The process described above reduces the quantity of flux per unit area on the finned side of the plate to a defined value of approx. 0.01 to 0.15 g/cm², in particular approx. 0.02 to 0.09 g/cm², while nevertheless ensuring reliable brazing.

The fluxing of the studded side, i.e. of the opposite side of the plate from the finned side, facing downward in the figures, is carried out by means of a second fluxing apparatus (not shown in the figure) via a separate circuit, since the pump and spraying apparatus settings for the finned-side coating should be set to a different, preferably lower value compared to the other side. The studded-side fluxing apparatus can be formed in a conventional way. However, it may also be advantageous to perform nonuniform, heterogeneous fluxing or coating on this side, if the preconditions for the brazing require or permit this.

A monitoring apparatus 10 with a plurality of monitoring units 10a, 10b, 10c is provided for monitoring the fluxing operation and therefore the flux thickness. Referring to FIG. 2, a laser which serves as emitter 11 and a receiver 12 are provided as first monitoring unit 10a. During each spray cycle, this first monitoring unit 10a monitors whether a flux spray jet is present. If the flux spray jet is absent, the belt is stopped and a warning signal is emitted. A corresponding monitoring unit (not shown) is also provided on the studded side.

A second monitoring unit 10b monitors whether there is sufficient flux 3 on the studded side, the laser belonging to this unit being provided at the exit of the dryer. In this case, monitoring involves determining whether or not a white coloration is present. The result of the monitoring, i.e. of whether a predetermined white color is present, i.e. sufficient flux has been applied, or the white color is insufficient, i.e. the studded side is still silver/aluminum-colored and consequently insufficient flux has been applied, is digitized and transmitted to the monitoring apparatus 10. The latter outputs a corresponding signal, so that if necessary the corresponding part can be removed and the spray jet intensity corrected accordingly, or any other malfunction can be eliminated.

Furthermore, there is a third monitoring unit 10c, which monitors whether sufficient flux 3 is present on the finned side in the region indicated in FIG. 4. In this case, a two-channel laser is provided, the first channel of which is a digitized white color and corresponds to a layer weight of, for example, 0.02 to 0.05 g/cm². The second channel is a different digitized white color and corresponds to a layer weight of, for example, 0.05-0.1 g/cm².

In this case, the control is carried out as follows:

If the first channel responds, i.e. the predetermined layer weight is exceeded, statistical measured value evaluation of a number of subsequent measured values/measurements is carried out. An automatic setting of the spray time and/or spray quantity is set as a function of the evaluation of these measured values, for example a reduction in spray time, i.e. it is possible to lower the quantity of flux applied. If a plurality of, for example four successive, measurements with measured values in the desired value range are carried out, the statistical evaluation is commenced again.

When the second channel responds, the quantity of flux is too high. The quantity of flux is automatically adjusted downward.

A corresponding two-channel laser can also be used on the studded side in order to optimize the thickness of flux coating there too.

FIG. 5 shows a traffic light system which is arranged preferably above the stacking robot to allow improved monitoring of the conveyor belt. This displays the signals from the monitoring apparatus 10 optically and acoustically. For the individual functions, reference should be made to the description in FIG. 5.

According to the invention, it may be advantageous if the quantity of flux is distributed inhomogeneously over the component. In this case, regions with an even distribution may be present next to regions with an uneven distribution and/or with the same distribution but a different quantity. In this case, by way of example, a region comprising 50% by weight may be present next to regions comprising 30% by weight and 20% by weight. This may be advantageous in heat exchangers having a collection manifold on one side. According to the invention, it may also be advantageous if two regions comprising approx. 40% by weight are present next to a region comprising 20% by weight or two regions each comprising 10% by weight. This may be expedient in the case of a heat exchanger with two collection manifolds on two opposite sides.

### LIST OF DESIGNATIONS

1 Fluxing apparatus
2 Workpiece
3 Flux
4 Cup-like region
5 Spray gun
10 Monitoring apparatus
10a First monitoring unit
10b Second monitoring unit
10c Third monitoring unit
11 Emitter
12 Receiver

1. An apparatus for the automated application of flux to a material surface using at least one spraying apparatus, characterized in that the flux is distributed unevenly or inhomogeneously or heterogeneously over the surface, preferably so as to form at least one zone to which more flux is applied and at least one zone to which less flux is applied.

2. The apparatus as claimed in claim 1, characterized in that one, two, three or more spraying apparatuses are used.

3. An apparatus for the automated application of flux to a material surface using at least one spraying apparatus, in particular as claimed in claim 1, characterized in that the at least one spraying apparatus is inclined at an angle of 30° to 60° with respect to the material surface, and if appropriate is arranged in a region in the vicinity of an edge of the material surface.

4. The apparatus as claimed in claim 3, characterized in that the spraying apparatus is arranged at an angle of 40° with respect to the material surface.

5. The apparatus as claimed in claim 1, characterized in that the material surface is arranged horizontally.

6. The apparatus as claimed in claim 1, characterized in that the material surface is formed by one side of a plate of a plate-type heat exchanger, such as a plate-type radiator or plate-type evaporator, with the spraying apparatus arranged on its cup-side surface.

7. The apparatus as claimed in claim 6, characterized in that the material surface is formed by the finned side of the plate.

8. The apparatus as claimed in claim 6, characterized in that the material surface is formed by the studded side of the plate.

9. The apparatus as claimed in claim 1, characterized in that the apparatus has a monitoring apparatus (10) which is used to monitor the flux coating.

10. The apparatus as claimed in claim 9, characterized in that the monitoring apparatus (10) has a plurality of monitoring units (10a, 10b, 10c).

11. The apparatus as claimed in claim 1, characterized in that the monitoring apparatus (10) is an optical monitoring apparatus (10).

12. The apparatus as claimed in claim 9, characterized in that the monitoring apparatus (10) has a monitoring unit (10a) which monitors the spray jet.

13. The apparatus as claimed in claim 9, characterized in that the flux quantity is detected, evaluated and the process adjusted within the time required for the manufacturing process.

14. The apparatus as claimed in claim 9, characterized in that the monitoring apparatus (10) has a monitoring unit (10b, 10c) which monitors the layer thickness.

15. A process for applying a flux (3) for brazing parts, in particular based on aluminum as base material, using at least one spraying apparatus, characterized in that the spray jet which is discharged by at least one spraying apparatus is discharged inclined at an angle other than 90° with respect to the material surface, in which case it is possible that some of the spray jet will not come into contact with the material surface.

16. A process for applying a flux (3) for brazing parts, in particular based on aluminum as base material, using at least two spraying apparatuses, characterized in that the spray jets discharged from at least two spray nozzles are discharged with different spray intensities.

17. A process for applying a flux for brazing parts, in particular based on aluminum as base material, using a spray nozzle, characterized in that the apparatus as claimed in claim 1.

18. The process as claimed in claim 15, characterized in that from 0.02 to 0.1 g of flux (3) per square centimeter is applied.

19. The process as claimed in claim 13, characterized in that the quantity of flux (3) applied is monitored by means of a monitoring apparatus (10).

20. A heat exchanger comprising a large number of components which can be brazed to one another, in which the process and/or the apparatus from claim 1 is used to apply a flux.
